(19) United States
(12) Patent Application Publication
(10) Pub. No.: US 2019/0188130 A1
(43) Pub. Date: Jun. 20, 2019

(54) Data Storage Device and Non-Volatile Memory Control Method

(71) Applicant: Silicon Motion, Inc., Jhubei City (TW)

(72) Inventors: Jieh-Hsin Chien, Taoyuan City (TW); Yi-Hua Pao, Hsinchu City (TW)

(73) Assignee: Silicon Motion, Inc.

(21) Appl. No.: 16/283,382

(22) Filed: Feb. 22, 2019

Related U.S. Application Data
(63) Continuation of application No. 15/710,048, filed on Sep. 20, 2017.
(60) Provisional application No. 62/427,090, filed on Nov. 28, 2016.

(30) Foreign Application Priority Data
Feb. 6, 2017 (TW) 106103787

(51) Int. Cl. G06F 12/02

(52) U.S. Cl. CPC G06F 12/0284; G06F 13/18; G06F 12/0246

(57) ABSTRACT

A hybrid data storage device is shown. In addition to a non-volatile memory, the hybrid data storage device has a volatile memory. A microcontroller of the data storage device generates and maintains a first mapping table and a second mapping table. According to the first mapping table, specific logical addresses are mapped to the volatile memory. The second mapping table records mapping information between logical addresses, including the specific logical addresses, and the non-volatile memory. When the data storage device is powered on, the microcontroller uploads data read from the non-volatile memory to the volatile memory according to the first mapping table and the second mapping table.

### CROSS REFERENCE TO RELATED APPLICATIONS

This application is a Continuation of pending U.S. patent application Ser. No. 15/710,048, filed Sep. 20, 2017, which claims priority to Taiwan Patent Application No. 106103787, filed on Feb. 6, 2017, and is also a non-provisional of U.S. Provisional Application No. 62/427,090 filed on Nov. 28, 2016, the entirety of which are incorporated by reference herein.

### BACKGROUND OF THE INVENTION

### Field of the Invention

The present invention relates to data storage devices and in particular to hybrid storage techniques.

### Description of the Related Art

There are various forms of non-volatile memory used in data storage devices for long-term data retention, such as a flash memory, magnetoresistive RAM, ferroelectric RAM, resistive RAM, and so on. However, operational efficiency of the data storage device is limited by the physical properties of non-volatile memory. How to improve the operational efficiency of data storage devices is an important issue in this field.

### BRIEF SUMMARY OF THE INVENTION

A data storage device in accordance with an exemplary embodiment of to disclosure comprises a non-volatile memory, a volatile memory and a microcontroller. The microcontroller generates and maintains a first mapping table and a second mapping table. When the data storage device is powered on, the microcontroller uploads data read from the non-volatile memory to the volatile memory according to the first mapping table and the second mapping table.

Both the first mapping table and the second mapping table may be indexed by logical address. The second mapping table may record the mapping between the logical addresses and a plurality of physical addresses of the non-volatile memory. The first mapping table records the mapping between the specific logical addresses and a plurality of physical addresses of the volatile memory. The microcontroller may upload the first mapping table read from the non-volatile memory to a dynamic area of the volatile memory.

The data may be uploaded to a specific-use area of the volatile memory. Furthermore, the data may be updated in the specific-use area, and the updated data may be not programmed to the non-volatile memory until a synchronization condition is met.

The logical addresses of the data may be sequential.

The microcontroller may maintain either the first mapping table or the second mapping table to respond to a request from a host.

The aforementioned techniques may be used to implement control methods for a non-volatile memory.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates the storage space of a flash memory 100;

FIGS. 2A, 2B and 2C depict the specific-use area in the DRAM in accordance with different exemplary embodiments of the disclosure;

FIG. 3 is a block diagram depicting a data storage device 300 in accordance with an exemplary embodiment of the disclosure;

FIG. 4 depicts the mapping information that has to be maintained in the data storage device 300;

FIG. 5 is a flowchart depicting operations of the data storage device 300 in accordance with an exemplary embodiment of the disclosure; and

FIG. 6 is a flowchart depicting operations of the data storage device 300 in accordance with another exemplary embodiment of the disclosure.

### DETAILED DESCRIPTION OF THE INVENTION

The following description shows exemplary embodiments carrying out the invention. This description is made for the purpose of illustrating the general principles of the invention and should not be taken in a limiting sense. The scope of the invention is best determined by reference to the appended claims.

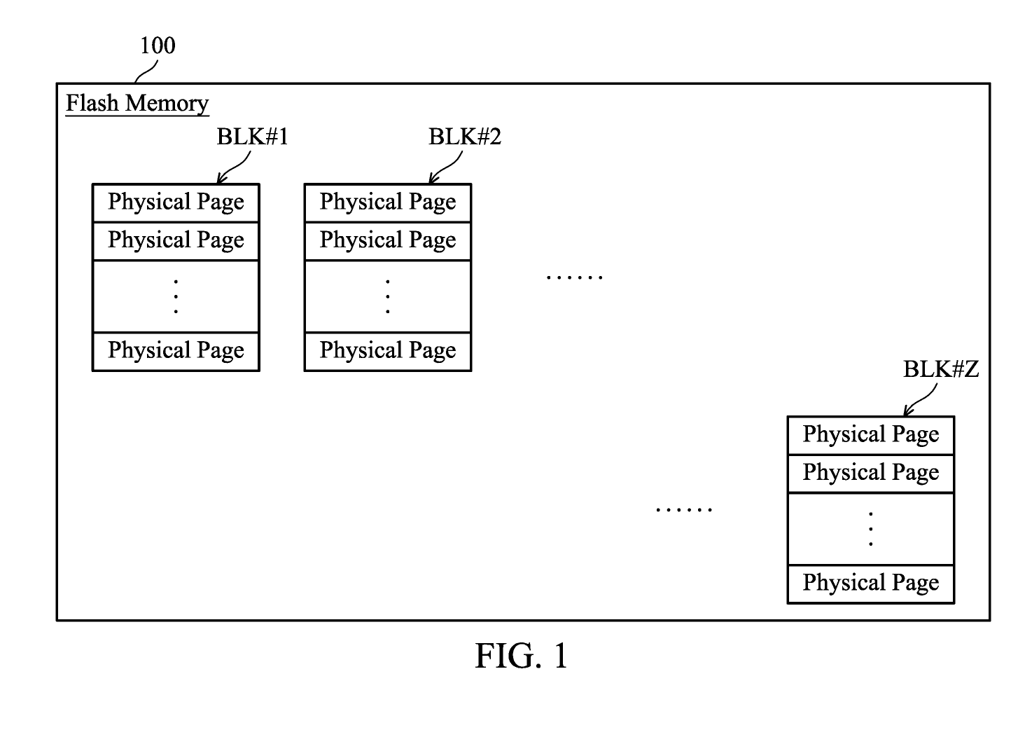

A non-volatile memory may be a memory device for long-term data retention such as a flash memory, a magnetoresistive RAM, a ferroelectric RAM, a resistive RAM, a spin transfer torque-RAM (STT-RAM) and so on. The following discussion is particularly regarding a flash memory as an example, but not intended to be limited thereto. FIG. 1 illustrates the storage space of a flash memory 100, which is divided into physical blocks BLK #1, BLK #2 BLK #Z, etc., where Z is a positive integer. Each physical block includes a plurality of physical pages. For example, one physical block may include 256 physical pages. Each physical page may be allocated to store data of a predetermined length. For example, each physical page may be allocated to store data of 16 KB.

The flash memory 100 is often used as a storage medium in today's data storage devices, for implementations of a memory card, a USB flash device, an SSD and so on. In another exemplary embodiment, the flash memory 100 is packaged with a controller to form a multiple-chip package and named eMMC.

When updating the data stored in the flash memory 100, the new data is written into a spare area rather than being rewritten over the storage space of the old data. The old data is invalidated. Frequent write operations make the storage space is flooded with invalid data. The storage space of the flash memory 100, therefore, is not efficiently used and the read/write speed of the flash memory 100 is slowed down. Read/write performance of the flash memory 100 is affected.

A garbage collection operation is introduced to process the physical blocks containing a lot of invalid data. The valid pages within a source block are copied to another physical block. The source block, therefore, finally contains only invalid pages and can be released by an erase operation. However, for each physical block, the number of affordable erase operations is limited. Frequent write operations may result in over-erased physical blocks and thereby damage data retention. The erase endurance of physical blocks of flash memory should be taken into consideration when designing a flash device.

A flash memory further involves read disturbance issues. During a read operation, high voltages are applied on the word lines surrounding the target word line. The memory cells operated by the surrounding word lines, therefore, are disturbed. The reliability of flash memory is damaged.

In response to at least the aforementioned operational bottlenecks of flash memory, the present invention proposes a hybrid data storage device. In addition to the flash memory 100 for non-volatile storage, a volatile memory is introduced to be coupled to the control unit of the data storage device. The volatile memory provides a specific-use area to share the burden of data storage of the flash memory 100. After being powered on, a part of the write requests received by the data storage device is changed to regard the specific-use area as the storage destination to avoid frequently writing data into the flash memory 100. The data written into the specific-use area is retained to respond to read requests and thereby the flash memory 100 is not frequently accessed. This manner effectively resolves the aforementioned read/write performance problem, as well as problems with the erase limitations of physical blocks and read-disturbance. The volatile memory may be a DRAM.

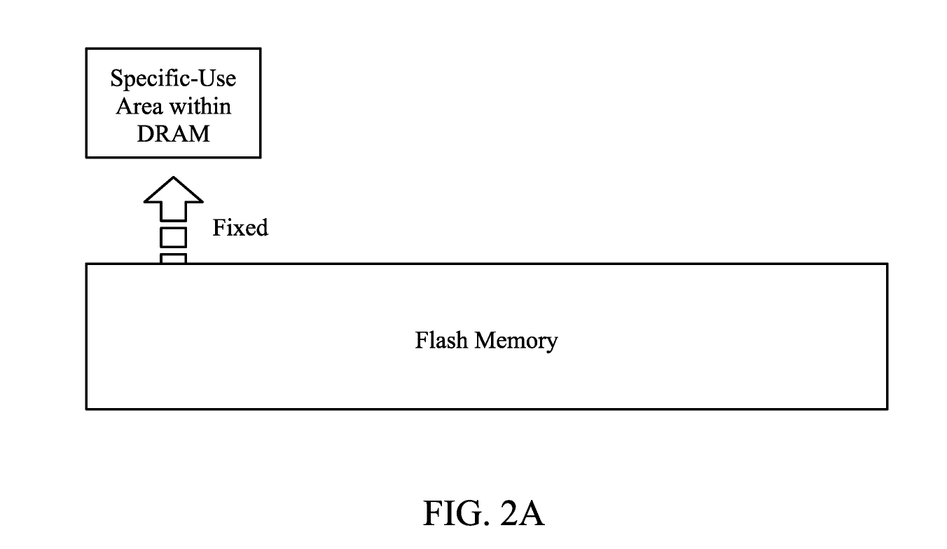

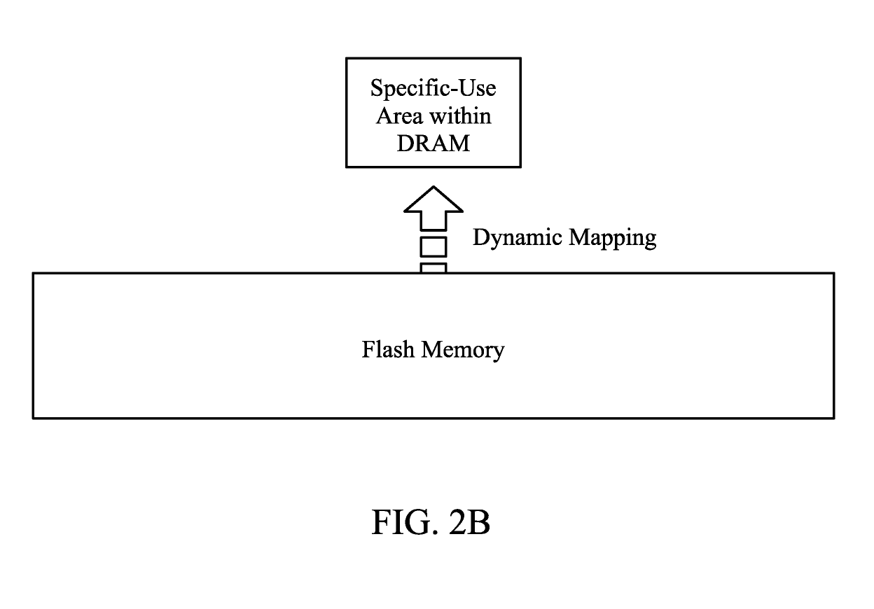

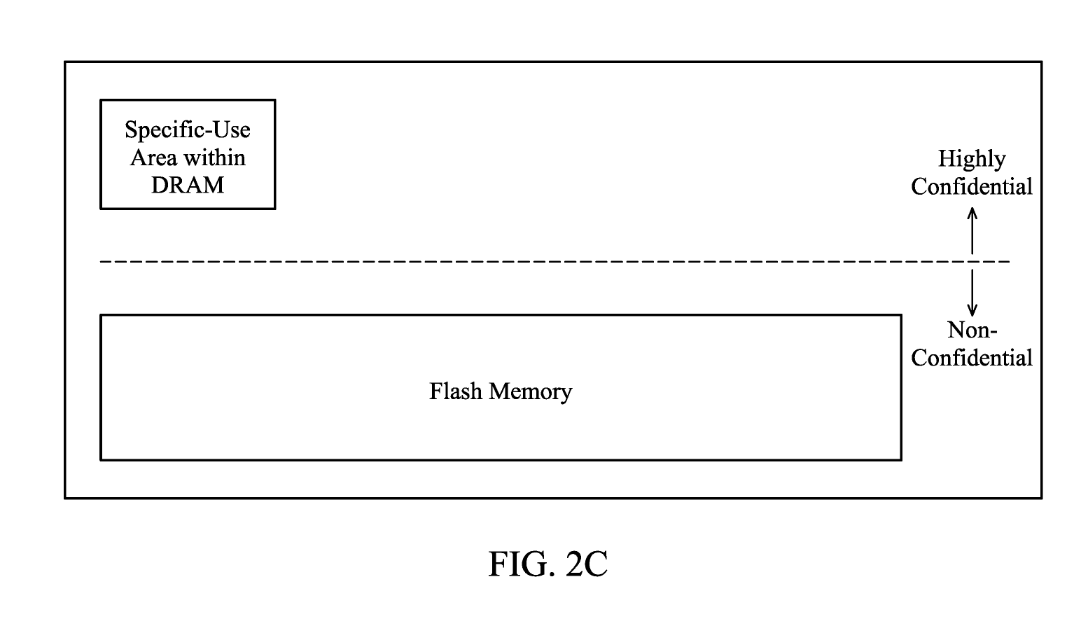

FIG. 2A depicts a DRAM allocated to provide a specific-use area to correspond to the initial area allocated in the flash memory. In an exemplary embodiment, the specific-use area is 128 MB and may correspond to the beginning 128 MB system file of an 8 GB flash memory. In other exemplary embodiments, the DRAM is allocated to provide the specific-use area to correspond to other fixed sectors.

In another exemplary embodiment, the DRAM provides a specific-use area of 128 MB for storage of data within a predetermined range of a logical block address (LBA). For example, the specific-use area provided by the DRAM may be utilized for temporary storage of data within LBA#0 to LBA#262,143, the first established 262,144 LBAs. The first established LBAs may correspond to operating system (OS) files or application files which are frequently accessed. In the disclosure, OS files or application files are stored into the specific-use area of the DRAM to be accessed in real time. The data access efficiency, therefore, is considerably improved. The issues regarding erasure limitations of physical blocks and read disturbance of flash memory are resolved.

FIG. 2B depicts the specific-use area in the DRAM in accordance with another exemplary embodiment of the disclosure. Different from the exemplary embodiment of FIG. 2A that uses the DRAM to provide a specific-use area for a fixed sector of a flash memory, the exemplary embodiment of FIG. 2B allocates a specific-use area to correspond to a dynamically allocated space that is dynamically allocated in the flash memory for a particular file. For example, a specific-use area of 128 MB in the DRAM is provided for temporary storage of a particular file that is issued to be stored into the data storage device. For example, the specific-use area in the DRAM may be allocated for temporary storage of a game log file. The frequent read and write operations of the game log file are performed on the DRAM rather than on the flash memory. The read and write performance of a game log file, therefore, is considerably improved. The issues regarding erasure limitations of physical blocks and read disturbance of flash memory are resolved.

FIG. 2C depicts the specific-use area in the DRAM in accordance with another exemplary embodiment of the disclosure, which helps the operations of a printer. A data storage device may be mounted on a printer. The data storage device may include a flash memory and is operative to store print data uploaded by a user connected to the printer. The uploaded print data is waiting in the data storage device to be scheduled to be printed out. As described above, a DRAM is operated by a control unit of the data storage device and is allocated to provide a specific-use area. As shown in FIG. 2C, the specific-use area is provided to achieve the storage of highly confidential print data at the printer side. Note that the highly confidential print data is not written into the flash memory and is restricted to the specific-use area within the DRAM. The data storage device may further encrypt the highly confidential print data. Non-confidential print data is stored into the flash memory. When the printer is powered off or an unexpected power failure occurs, the highly confidential print data is destroyed forever due to the power loss at the DRAM. Thus, data confidentiality is guaranteed. Different from DRAM, the flash memory retains data even though an unexpected power failure event occurs or the data has been invalidated. If the highly confidential data is stored in the flash memory, there will be some risk in the data confidentiality.

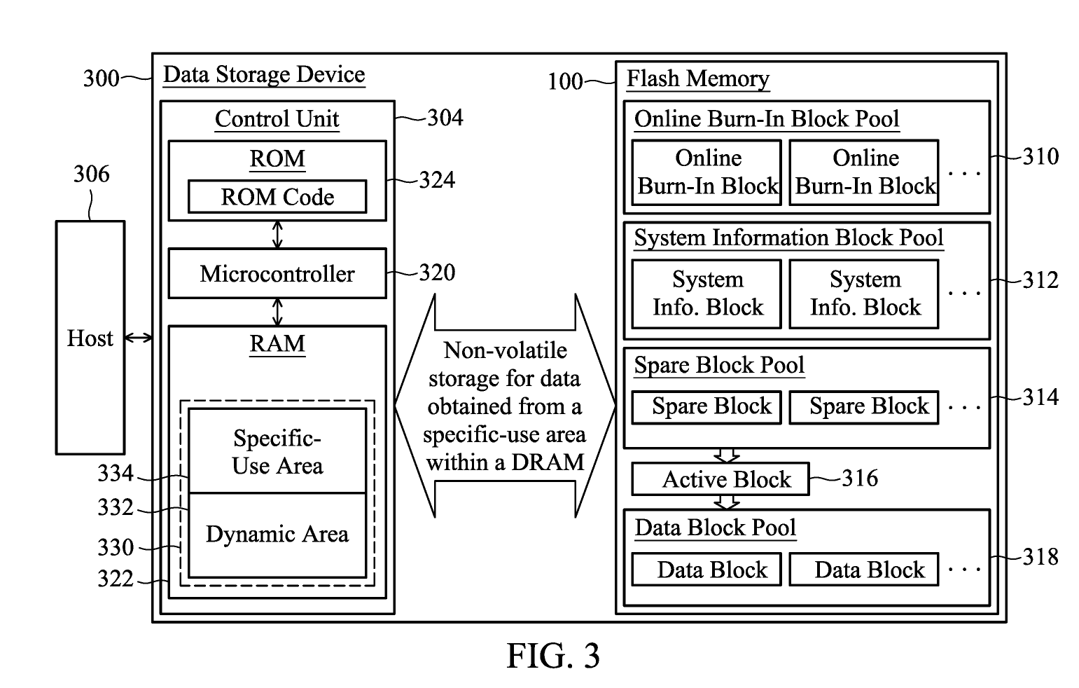

FIG. 3 is a block diagram depicting a data storage device 300 in accordance with an exemplary embodiment of the disclosure, which includes a flash memory 100 and a control unit 304. The control unit 304 is coupled between a host 306 and the flash memory 100 to operate the flash memory 100 based on the commands issued from the host 306.

In an exemplary embodiment, the flash memory 100 is allocated to provide an online burn-in block pool 310, a system information block pool 312, a spare block pool 314, an active block 316 and a data block pool 318. The blocks within the online burn-in block pool 310 store in-system programming (ISP) code. The blocks within the system information block pool 312 store system information such as mapping tables. The active block 316 is provided from the spare block pool 314 to receive data from the host 306. After the active block 316 finishes receiving data, the active block 316 is pushed into the data block pool 318.

The control unit 304 includes a microcontroller 320, a random access memory space 322 and a read-only memory 324. The random access memory space 322 may be divided into an internal RAM and an external RAM. The internal RAM and the microcontroller 320 may be fabricated on the same die, different from the external RAM that is not fabricated on the same die with the microcontroller 320. The random access memory space 322 may be implemented by DRAM(s) or/and SRAM(s). The read-only memory 322 stores ROM code. The microcontroller 320 operates by executing the ROM code obtained from the read-only memory 324 or/and the ISP code obtained from the online burn-in block pool 310 of the flash memory 100.

In an exemplary embodiment, a DRAM 330 (not limited to the aforementioned internal RAM or external RAM) belonging to the random access memory space 322 provides a dynamic area 332 as well as a specific-use area 334. The dynamic area 332 is for temporary storage of mapping tables or computing data. The temporary storage of computing data implements a cache function for instruction prediction or prefetching data and so on. The storage function of the flash memory 100 is shared by the specific-use area 334. Thus, the operational performance of the data storage device 300 is not overly limited by the physical properties of the flash memory 100. The specific-use area 334 may work as that taught in FIG. 2A, FIG. 2B or FIG. 2C. Based on FIG. 2A, the specific-use area 334 may store OS files or App files to share the burden of data storage of the flash memory 100. Based on FIG. 2B, the specific-use area 334 may store game log files to share the burden of data storage of the flash memory 100. Based on FIG. 2C, the specific-use area 334 may store highly confidential print data to share the burden of data storage of the flash memory 100.

FIG. 3 further shows the communication between the control unit 304 and the flash memory 100 for non-volatile storage of the data temporarily stored in the specific-use area 334. When the data storage device 300 is powered on, specific data is downloaded from the flash memory 100 to the specific-use area 334 by the microcontroller 320 and read/write requests for the specific data are changed to be performed on the specific-use area 334. In this manner, there is no need to upload (commit) the updated version of the specific data from the specific-use area 334 to the flash memory 100 in real time. Furthermore, it is not required to access the flash memory 100 when a read request for the specific data is issued. The read request for the specific data is responded to by the data read from the specific-use area 334. As for the updated version of the specific data in the specific-use area 334, the synchronization condition for synchronization between the specific-use area 334 and the flash memory 100 may depend on the user. For example, the updated version of the specific data in the specific-use area 334 may be uploaded to the flash memory 100 periodically in time (in accordance with a time limit) to cope with an unexpected power failure event. Before powering off the data storage device 300, the updated version of the specific data in the specific-use area 334 is also uploaded to the flash memory 100. Thus, the latest version of the specific data is guaranteed kept in the flash memory 100 after the data storage device 300 has been powered off.

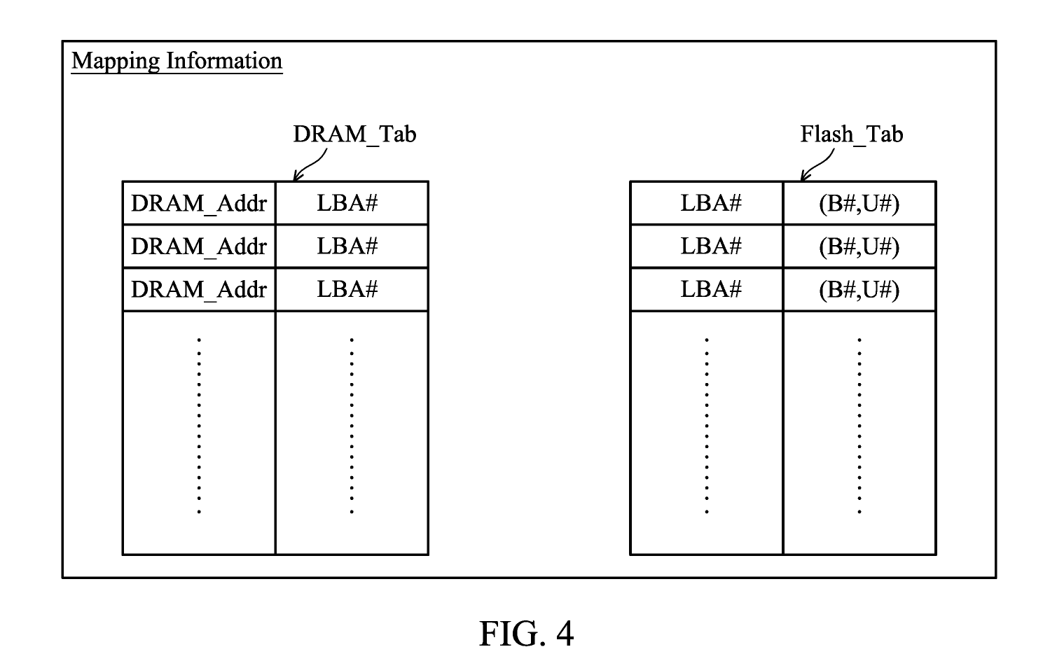

FIG. 4 depicts the mapping information that has to be maintained in the data storage device 300. The mapping table DRAM_Tab lists logical addresses requested by the host 306 and corresponding to the specific-use area 334 within the DRAM 330. As shown, the mapping table DRAM_Tab is searched according to DRAM addresses DRAM_Addr. The logical block addresses LBA# corresponding to the different addresses of the specific-use area 334 are listed in the mapping table DRAM_Tab. The mapping table Flash_Tab is provided to indicate the flash memory space for the different logical addresses requested by the host 306. As shown, each logical block address LBA# corresponds to one unit U# of one physical block B#. Generally, one physical page is divided into four units numbered from U0 to U3. In another exemplary embodiment, the mapping table DRAM_Tab is searched according to logical block address LBA# rather than according to DRAM address DRAM_Addr. The mapping table Flash_Tab may be replaced by other tables that also show the logical-to-physical mapping relationship for the host 306 to operate the flash memory 100.

When the host 306 requests to access data of a particular logical block address LBA#, the control unit 304 may check the mapping table DRAM_Tab to determine whether the particular logical block address LBA# corresponds to any DRAM address DRAM_Addr. When a DRAM address DRAM_Addr is gained, it means that the read/write request for the particular logical block address LBA# should be implemented by accessing the DRAM 330 according to the DRAM address DRAM_Addr. When the mapping table DRAM_Tab shows that the particular logical block address LBA# corresponds to no DRAM address, the read/write request for the particular logical block address LBA# is performed based on the mapping table Flash_Tab to read/write the flash memory 100.

In addition to the mapping information stored in the mapping table DRAM_Tab for the specific-use area 334, the mapping table Flash_Tab also contains mapping information for non-volatile storage of the data temporarily stored in the specific-use area 334. The microcontroller 320 may use the dynamic area 332 to dynamically manage the mapping information (e.g., the mapping tables DRAM_Tab and Flash_Tab). The microcontroller 320 further uploads the mapping information from the dynamic area 332 to the flash memory 100 for non-volatile storage.

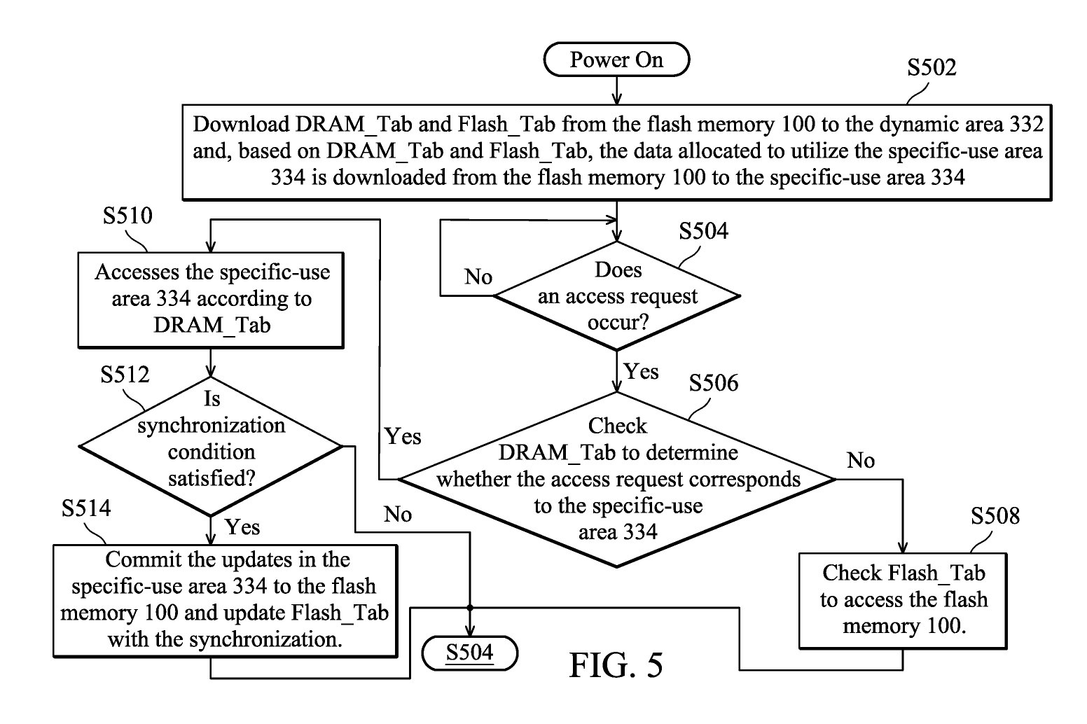

FIG. 5 is a flowchart depicting operations of the data storage device 300 in accordance with an exemplary embodiment of the disclosure. After the data storage device 300 is powered on, step S502 is performed and the microcontroller 320 downloads the mapping tables DRAM_Tab and Flash_Tab from the flash memory 100 to the dynamic area 332 and, based on the mapping tables DRAM_Tab and Flash_Tab, the data allocated to utilize the specific-use area 334 is downloaded from the flash memory 100 to the specific-use area 334. When it is determined in step S504 that an access request (read/write) occurs, step S506 is performed to check the mapping table DRAM_Tab to determine whether the access request corresponds to the specific-use area 334 and should be performed on the specific-use area 334. If not, the microcontroller 320 checks the mapping table Flash_Tab in step S508 to access the flash memory 100. If yes, step S510 is performed and the microcontroller 320 accesses the specific-use area 334 according to the mapping information obtained from the mapping table DRAM_Tab. The flash memory 100, therefore, is not that frequently accessed due to the design of the specific-use area 334. In step S512, a synchronization condition that has to be satisfied for synchronization between the specific-use area 334 and the flash memory 100 is checked. If the synchronization condition is satisfied, the microcontroller 320 performs step S514 to upload data from the specific-use area 334 to the flash memory 100 and the mapping table Flash_Tab is updated with the synchronization. The monitoring step S504 for the access requests may continue until the data storage device 300 is powered off.

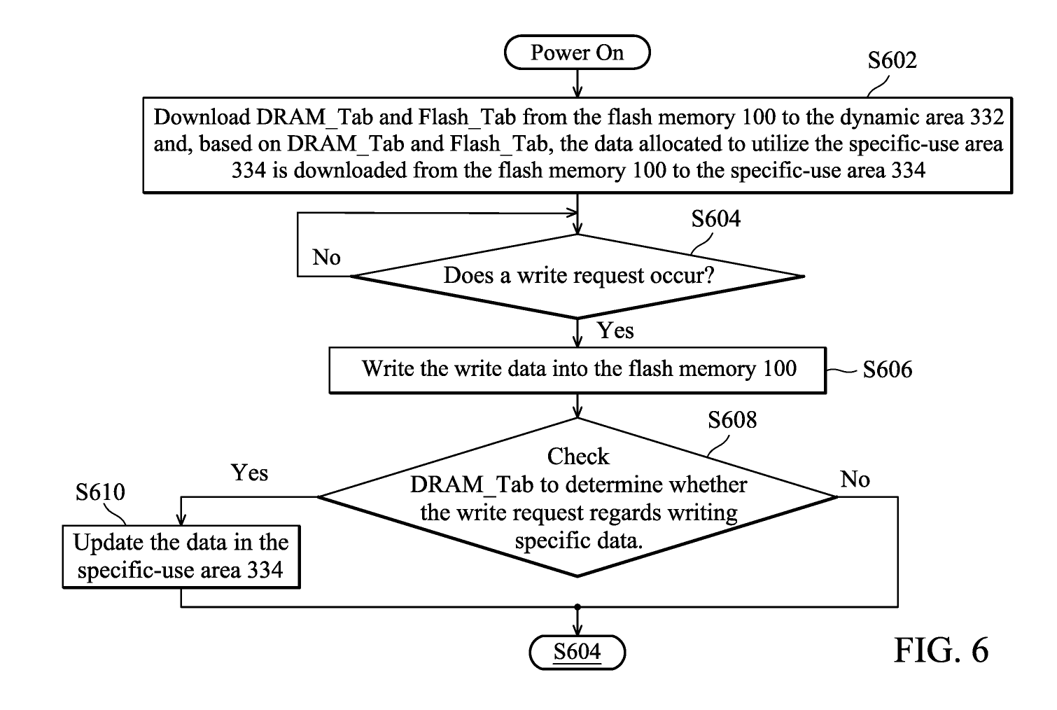

FIG. 6 is a flowchart depicting operations of the data storage device 300 in accordance with another exemplary embodiment of the disclosure. To protect the data from being lost, the flash memory 100 is synchronized with the specific-use area 334 in real time. The concept of using the specific-use area 334 to share the burden of data storage of the flash memory 100 to protect the flash memory 100 from being overly accessed is similar to that discussed in FIG. 5. For simplicity, FIG. 6 focuses on write operations. When the data storage device 300 is powered on, step S602 is performed and the microcontroller 320 downloads the mapping tables DRAM_Tab and Flash_Tab from the flash memory 100 to the dynamic area 332. Based on the mapping tables DRAM_Tab and Flash_Tab, the data corresponding to the specific-use area 334 is downloaded from the flash memory 100 to the specific-use area 334. When it is determined in step S604 that a write request is received, step S606 is performed and the microcontroller 320 writes the write data into the flash memory 100 and updates the mapping table Flash_Tab accordingly. In step S608, the microcontroller 320 further checks the mapping table DRAM_Tab to determine whether the write request regards writing specific data that should has a copy in the specific-use area 334 to share the burden of data storage of the flash memory 100 to prevent the flash memory 100 from being overly accessed and thereby to solve the read disturbance problem on the flash memory 100. If yes, the microcontroller 320 performs step S610 and updates the data in the specific-use area 334 for unified data in the specific-use area 334 and the flash memory 100. The monitoring step S604 for write requests may continue until the data storage device 300 is powered off.

Other techniques that use the aforementioned concepts of hybrid data storage techniques are within the scope of the disclosure. Based on the above contents, the present invention further relates to methods for operating a data storage device.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a non-volatile memory;
a volatile memory; and
a microcontroller for generating and maintaining a first mapping table and a second mapping table,
wherein:
according to the first mapping table, specific logical addresses are mapped to the volatile memory;
the second mapping table records mapping information between logical addresses, including the specific logical addresses, and the non-volatile memory,
when the data storage device is powered on, the microcontroller uploads data read from the non-volatile memory to the volatile memory according to the first mapping table and the second mapping table.

2. The data storage device as claimed in claim 1, wherein both the first mapping table and the second mapping table are indexed by logical address.

3. The data storage device as claimed in claim 1, wherein the second mapping table records the mapping between the logical addresses and a plurality of physical addresses of the non-volatile memory.

4. The data storage device as claimed in claim 1, wherein the first mapping table records the mapping between the specific logical addresses and a plurality of physical addresses of the volatile memory.

5. The data storage device as claimed in claim 1, wherein the data is uploaded to a specific-use are of the volatile memory.

6. The data storage device as claimed in claim 5, wherein the data is updated in the specific-use area, and the updated data is not programmed to the non-volatile memory until a synchronization condition is met.

7. The data storage device as claimed in claim 1, wherein the logical addresses of the data are sequential.

8. The data storage device as claimed in claim 1, wherein the microcontroller either maintains the first mapping table or the second mapping table to respond to a request from a host.

9. The data storage device as claimed in claim 5, wherein the microcontroller uploads the first mapping table read from the non-volatile memory to a dynamic area of the volatile memory.

10. A control method for a non-volatile memory, comprising:
providing a volatile memory;
generating and maintaining a first mapping table and a second mapping table; and
uploading data read from the non-volatile memory to the volatile memory according to the first mapping table and the second mapping table when a data storage device containing the non-volatile memory and the volatile memory is powered on,
wherein:
according to the first mapping table, specific logical addresses are mapped to the volatile memory; and
the second mapping table records mapping information between logical addresses, including the specific logical addresses, and the non-volatile memory.

11. The control method as claimed in claim 10, wherein both the first mapping table and the second mapping table are indexed by logical address.

12. The control method as claimed in claim 10, wherein the second mapping table records the mapping between the logical addresses and a plurality of physical addresses of the non-volatile memory.

13. The control method as claimed in claim 10, wherein the first mapping table records the mapping between the specific logical addresses and a plurality of physical addresses of the volatile memory.

14. The control method as claimed in claim 10, wherein the data is uploaded to a specific-use area of the volatile memory.

15. The control method as claimed in claim 14, wherein the data is updated in the specific-use area, and the updated data is not programmed to the non-volatile memory untile a synchronization condition is met.

16. The control method as claimed in claim 10, wherein the logical addresses of the data are sequential.

17. The control method as claimed in claim 10, further comprising:
maintaining either the first mapping table or the second mapping table to respond to a request from a host.

18. The control method as claimed in claim 14, further comprising:
uploading the first mapping table read from the non-volatile memory to a dynamic area of the volatile memory.
